(19) United States
(12) Patent Application Publication
(10) Pub. No.: US 2020/0039657 A1
(43) Pub. Date: Feb. 6, 2020

(54) Variable Cycle Hybrid Power and Propulsion System for Aircraft

(71) Applicant: Southwest Research Institute, San Antonio, TX (US)

(72) Inventors: David L. Ransom, San Antonio, TX (US); Jacob M. Delimont, San Antonio, TX (US)

(21) Appl. No.: 16/052,971

(22) Filed: Aug. 2, 2018

(51) Int. Cl. B64D 27/02; F02K 3/04; F02C 6/14; F02C 7/36; B64D 27/10; B64D 41/00; B64D 27/24; H02K 11/00; H02K 7/108; H02K 7/116; H02K 7/14; H02K 7/18

(52) U.S. Cl. CPC B64D 27/02; B64D 2027/026; F02C 6/14; F02C 7/36; B64D 27/10; B64D 41/00; B64D 27/24; H02K 11/0094; H02K 7/108; H02K 7/116; H02K 7/14; H02K 7/1823; F05D 2220/323; F05D 2220/76; F02K 3/04

(57) ABSTRACT

A hybrid propulsion system for an aircraft, the aircraft having a propulsor, such as a propeller or ducted fan. A motor/generator drives the propulsor and/or generates electrical energy to be stored in an on-board battery pack. A power turbine is directly connected to the motor/generator via a power shaft, and is driven by exhaust from a gas generator system. The gas generator system has a compressor, a combustor, and a gas generator turbine that drives the compressor via a compressor shaft as well as produces exhaust gas output for the power turbine.

### TECHNICAL FIELD OF THE INVENTION

This invention relates to propulsion systems for aircraft, and more particularly to a hybrid propulsion system that may be powered by either a motor-battery combination or by a direct-coupled gas turbine engine powered by liquid fuel.

### BACKGROUND OF THE INVENTION

Research and development work has been ongoing for the purpose of developing hybrid power and propulsion technologies for heavier than air vehicles. The hybrid system concept typically consists of an electric propulsion system (i.e. a ducted fan) and a fuel-to-electric system (i.e. gas turbine generator). The “hybrid” aspect of the system essentially comes from the presence of both fuel and battery energy storage, and the ability to draw from either fuel or battery to power the propulsion system. The purpose of this technology is to have quiet propulsion when needed and the capability to generate electricity for recharge when quiet is no longer needed.

One of the significant challenges in hybrid aircraft propulsion is meeting weight performance goals. Weight is a significant factor of the hardware required to drive high power motors and to rectify and regulate such large amounts of generated power.

### DESCRIPTION OF THE DRAWINGS

A complete understanding of the present embodiments and advantages thereof may be acquired by referring to the following description taken in conjunction with the accompanying drawings, in which like reference numbers indicate like features, and wherein:

FIG. 1 illustrates a propulsion system in accordance with the invention.

FIG. 2 illustrates an example of requirements for a propulsion system.

FIG. 3 illustrates how computer modeling may be used to determine a compressor pressure ratio.

FIG. 4 illustrates how computer modeling may be used to determine a combustor firing temperature.

FIG. 5 illustrates how computer modeling may be used to determine a fan pressure ratio.

FIG. 6 illustrates how computer modeling may be used to determine performance of the propulsion system.

FIG. 7 illustrates the propulsion system of FIG. 1, but with a non-ducted propeller.

FIG. 8 illustrates the propulsion system of FIG. 1, but with a gearbox and clutch.

FIG. 9 illustrates the propulsion system of FIG. 1, but with a dual shaft in the gas generator system.

FIG. 10 illustrates the propulsion system of FIG. 1, but with a nozzle to make use of exhaust from the power turbine.

### DETAILED DESCRIPTION OF THE INVENTION

The following description is directed to a variable cycle aircraft propulsion system, which is either powered by an electric motor or by a gas turbine engine. This system is the aircraft's power system as well as its propulsion system, operating to power on-board electronics as well as to propel the aircraft. The power and propulsion systems are integrated to result in improved overall system weight and size.

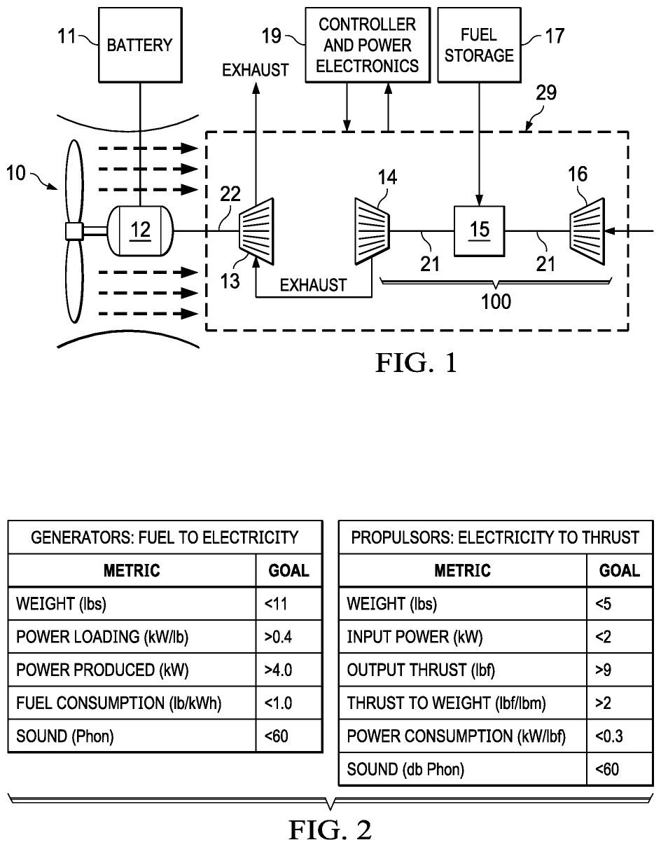

FIG. 1 illustrates a hybrid propulsion system for an aircraft, in accordance with the invention. The aircraft may be any type of aircraft, manned or unmanned, but a particular motivation for quiet hybrid propulsion systems is for surveillance applications with unmanned aircraft.

The aircraft is assumed to have a ducted fan or an open propeller or other such aerodynamic device to generate thrust. The propulsion system may have more than one such fan or propeller, referred to herein as a “propulsor” 10. In the example of FIG. 1, the propulsor 10 has a ducted configuration.

The hybrid propulsion system comprises two primary activation sources for the propulsor 10: an electric motor/generator 12 and a gas generator 100 to a power turbine 13. The gas generator 100 drives the power turbine 13, which drives the motor/generator 12 and the propulsor 10.

The electric motor/generator 12 drives the propulsor 10 and generates electricity. Electrical power not used for propulsion is stored in a battery bank 11.

In the gas generator system 100, a gas generator turbine 14 drives a gas generator compressor 16. A combustor 15 energizes compressed air from the compressor 16, which pressurizes atmospheric air. A fuel storage reservoir 17 stores fuel for the combustor 15. The combination of turbine 14, compressor 16, and combustor 15 comprises the “gas generator” 100. Various fuels may be combusted, with gasoline being one example.

A feature of gas generator turbine 14 is that its only function is to drive the associated compressor 16. A gas generator shaft 21 connects these two components, and nothing else is driven by this shaft 21. Any remaining fluid power from gas generator turbine 14 exits turbine 14 as an energetic exhaust flow to drive the power turbine 13. Thus, other than for driving compressor 16, all energy produced by gas generator system 13 is expended to power turbine 13.

Power shaft 22 connects three elements: power turbine 13, motor/generator 12, and propulsor 10. Thus, all energy produced by power turbine 13 is expended to either motor/generator 12 for electric power generation or to propulsor 10 for thrust. Excess exhaust is emitted to atmosphere.

Motor/generator 12 serves two purposes, depending on the operating mode of the propulsion system, as explained below. The propulsor 10 serves a full-time purpose of propelling the aircraft.

A controller 19 has appropriate hardware and software, programmed to provide the control signals for operating the propulsion system as described herein. Controller 19 moves electricity in and out of DC battery pack 11, converting either from or to multiple phases of alternating current. Variable speed operation is required for the propulsion system to allow for thrust variations associated with take-off, climb and cruise flight conditions. Controller 19 is programmed to control motor/generator 12 and gas generator system 100 to produce various flight modes as described below.

Controller 19 and its associated power electronics components are both heavy and sources of heat. Aside from the battery pack 11 and the fuel storage 17, these electrical components are likely the heaviest parts of the propulsion system. Therefore, a feature of the propulsion system described herein is an integrated power/propulsion system, which provides an opportunity to reduce the weight of the power electronics.

It is anticipated that the gas generator system 100 will be contained within a housing 29, which can be evacuated during all-electric operation of the aircraft. This minimizes any windage losses from the power turbine 13 during that flight mode. If using a ducted fan as the propulsor, a vacuum may be achieved by taking advantage of the local low static pressure in the fan duct.

Operating Modes

The propulsion system of FIG. 1 has three operating modes, the selection of which depends on the aircraft's mission and/or its power and propulsion needs at any given time. The different modes allow the same propulsion system to behave like different cycles, thus the “variable cycle” descriptor.

For maximum power events such as take-off and climb, the propulsion system operates in a maximum power mode. It operates at both maximum power from power turbine 13, to drive the propulsor 10, and maximum power from generator 12, powering onboard electrical equipment and charging battery pack 11. This maximum power mode consumes stored fuel of the gas generator system 100.

A second operating mode is a cruise mode, which requires less than maximum power from power turbine 13 to drive the propulsor 10. Electrical generation by motor/generator 12 maintains battery charge and powers onboard electrical equipment. The cruise mode uses stored fuel delivered to the gas generator system.

Both the maximum power mode and the cruise mode are “gas generator modes”, in which the gas generator system 100 is active, providing hot gas to the power turbine 13. The power turbine 13 drives propulsor 11 and the generator feature of motor/generator 12. Thus, there are two products from these gas generator modes: vehicle propulsion and electric power generation. The main motivation for hybrid propulsion for aircraft is quiet operation, and it is not likely that quiet is needed during any of these phases of flight.

In both the maximum power mode and the cruise mode, energy originates at the fueled combustor 15 to drive the gas generator system 100. This is analogous to a turbo-prop or turbo-fan system, but with the ability to generate electrical power for other electrical systems on-board the aircraft.

A third mode is a quiet loiter mode, in which aircraft propulsion is all-electric. The gas generator system 100 is deactivated. The motor/generator 12 is powered by battery pack 11 to drive the propulsor 10. On-board electrical systems may also be powered from battery pack 11. This quiet mode requires the least amount of propulsive power. If the battery storage supply nears empty, the aircraft can re-enter the cruise mode which uses the gas generator system 100 to drive the propulsor 11 and puts the motor/generator 12 in generation mode to replenish the batteries.

In the quiet loiter (electric) mode, the power turbine 13 is simply along for the ride on the main power shaft 22. Power turbine 13 free-wheels, and may be contained in an evacuated housing 29. The housing 29 can be evacuated by any convenient means, such as a low static pressure region in a ducted fan or a vacuum pump carried as an accessory.

During quiet mode, motor/generator 12 transitions to motoring operation. It drives propulsor 10 at a relatively low power, and extracts energy from the onboard battery pack 11.

Propulsion System Sizing

FIG. 2 illustrates an example of a requirements chart for the propulsion system of FIG. 1. Such requirements are often the starting point for propulsion system design, especially for aircraft to be used for missions such as surveillance.

For the power generation (fuel-to-electricity) system, there are weight, power, efficiency, and noise requirements. Analogous requirements are listed for the propulsion (electricity to thrust) system as well. The two requirement sets are not directly matched in terms of power, indicating that the fuel-to-electricity system has the ability both to drive the propulsion system and to provide additional electrical power for battery charging and onboard electrical systems.

In the example of FIG. 2, the propulsion system is to provide an output thrust of at least 9 lbf and consume no more than 2 kW of electrical power. The fuel-to-electric system is to produce at least 4 kW of power, well in excess of the propulsion motor drive power.

For an integrated propulsion system, such as the system of FIG. 1, an efficiency requirement can be expressed at a system level. A specific fuel consumption (SFC) characteristic can be defined, which includes the power associated with net electrical power generated by the system as well as the power associated with the propulsion of the vehicle. The units of measurement are in terms of pound-mass per kilowatt hours.

$$SFC = \frac{{W}_{fuel}}{( GenPwr + Thrust \cdot Velocity )} = \frac{lbm}{kW \cdot hr}$$

Given the requirements of FIG. 1 and the efficiency requirement, the sizing of the propulsion system can be determined. In particular, for purposes of this description, the goals of weight can be met or surpassed with a reduction in weight of the components associated with motor/generator operations, as compared to other hybrid designs.

The efficiency requirement determines two characteristics of the fuel-to electric system 100. For any fuel-to-electric system, there are two main drivers in the sizing of the machinery: the compressor pressure ratio and the firing temperature. The pressure ratio directly influences the efficiency, so one can start with an efficiency requirement and work backward to solve for pressure ratio. The firing temperature influences the power density of the machine, and thus the final size of the machinery. Essentially, the turbine power is proportional to mass flow and the change in enthalpy.

Given the configuration of FIG. 1 and a set of requirements, mechanical modeling can be used for sizing analysis. An example of a commercially available propulsion system analysis tool is the Numerical Propulsion System Simulation (NPSS™) simulation software tool. Using the model, performance requirements can be evaluated across a range of assumed values for a particular system characteristic.

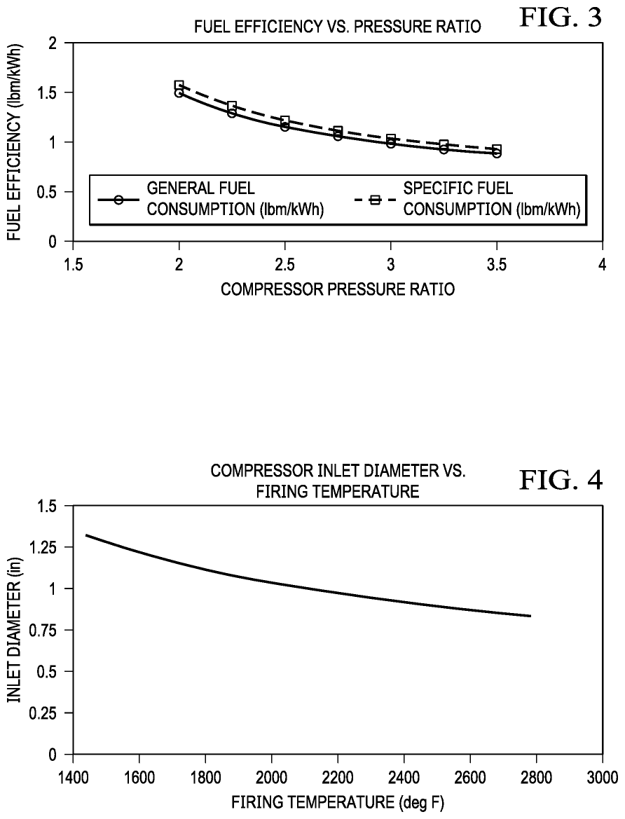

FIG. 3 illustrates an example of how modeling may be used to determine compressor pressure ratio. A propulsion system model is used to run a sweep of solutions for a specified value of compressor pressure ratio. In FIG. 3, two fuel efficiency parameters are plotted as a function of compressor pressure ratio. The generator fuel consumption is calculated to enable a direct comparison to the example requirements of FIG. 2. In addition, the hybrid system SFC is also calculated. The requirements of FIG. 2 require less than 1.0 lbm/kWh fuel consumption. According to these results, this means that a pressure ratio of 3.0 is required for compressor 16.

As illustrated in FIG. 4, a similar analysis can be performed to determine the effects of combustor firing temperature on sizing of the gas generator system 100. Because the air flow rate is determined essentially by the power level and the firing temperature, another constraint is necessary to determine a flow area. To accomplish this, the inlet Mach number of the compressor 16 was set to 0.2. This allows for an inlet diameter to be calculated for the compressor 16. As shown in FIG. 4, a higher firing temperature results in a decreased inlet diameter. A temperature ratio from engine inlet to burner exit of 6.0 results in an inlet diameter of less than 0.85 inches. The consequence of an increasing firing temperature is either a significantly reduced turbine life or a need for a cooled turbine design. For the sake of example herein, it is assumed that the turbine 14 will not be cooled, leading to a maximum temperature ratio of about 4.0, thus a firing temperature of 1635° F. and an associated compressor inlet diameter of about 1.2 inches.

Another important driver for sizing the propulsion system is the pressure ratio of the propulsor 11. This pressure ratio directly influences the energy efficiency of the system. Using the propulsion system model, the propulsor performance is evaluated across a range of assumed pressure ratio values.

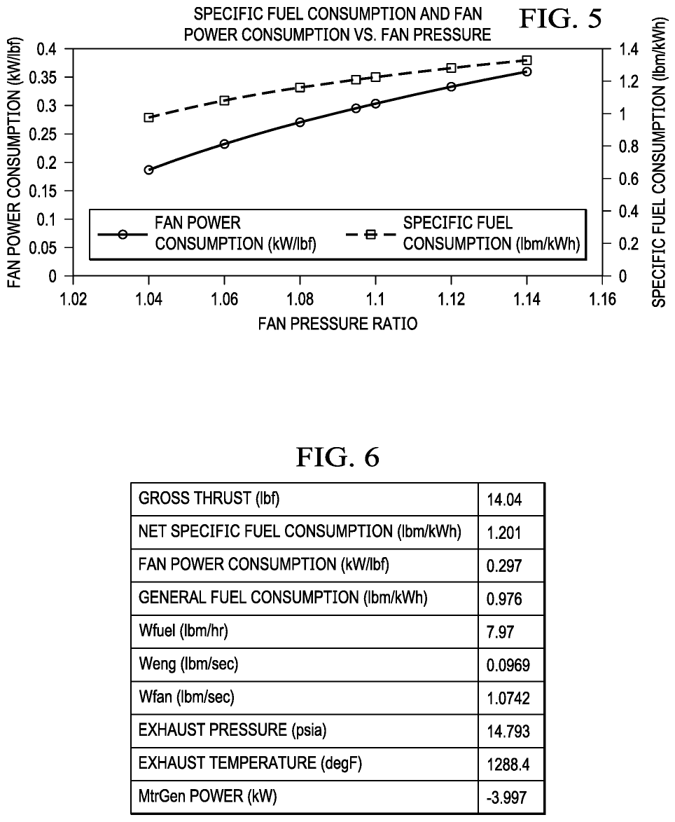

FIG. 5 is an example of how fan pressure ratio may be determined. As illustrated in FIG. 5, a pressure ratio range is from 1.04 to 1.14 with associated values for fan power consumption and system SFC. Per the requirements of FIG. 2, the fan power consumption goal is <0.3 kW/lbf. This performance is achieved at a pressure ratio of 1.095. At this same condition, the SFC is 1.213 lbm/kWh.

In this manner, computer modeling and simulation can be used to determine characteristics of the propulsion system, such as the above-described compressor pressure ratio, cycle temperature ratio, and fan pressure ratio. As stated above, the pressure ratio values are dictated by efficiency requirements, and the temperature ratio is a compromise between system size and complexity.

Given a propulsion system configuration, computer modeling can also be used to calculate performance, for a particular design point. For example, a design point might be the beginning of climb of the aircraft. This is a high-power condition about thrust as well as the need to generate electricity for payloads, avionics, etc.

FIG. 6 illustrates propulsion system performance, for the beginning of climb design point. Considering the requirements listed above, this design point analysis includes the assumption that both sub-systems are at full power. Because this is the highest load condition, this design point determines the size/weight of the power electronics.

Of significance is the motor/generator power demanded by the propulsion system, which is about 4 kW. This may be compared to other hybrid systems, in which a generator demands one measure of power to supply all necessary power, and a motor demands another measure of additional power for the propulsion system.

Propulsion System Variations

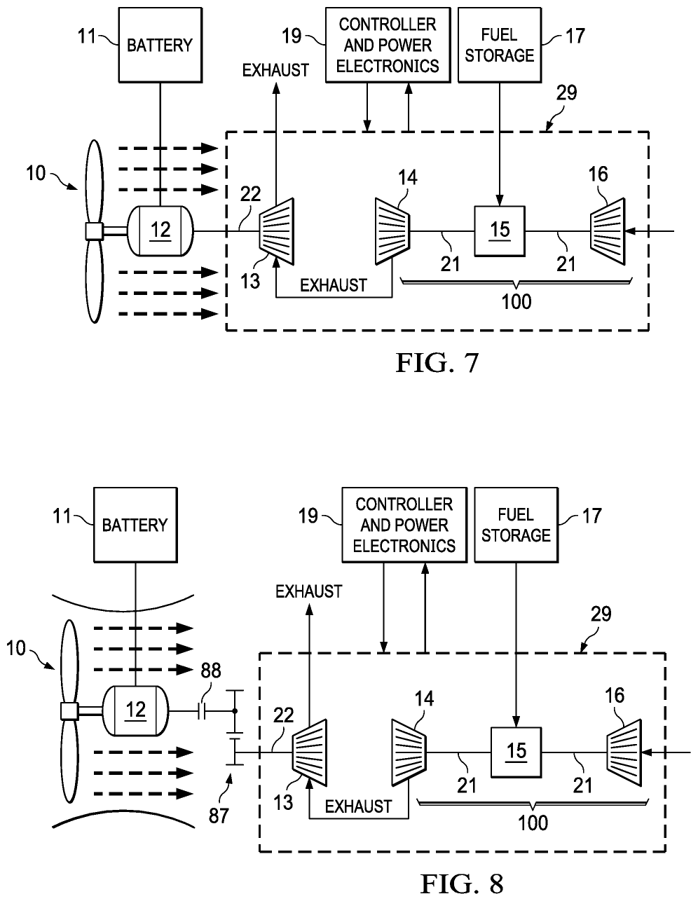

FIGS. 7-10 illustrate various enhancements of the propulsion system of FIG. 1. All embodiments have the same essential characteristics: a propulsor drive motor/generator 12 and a power turbine 13 that drives the propulsor 10.

In FIG. 7 the propulsor 10 is an open fan or propeller instead of a ducted unit.

In FIG. 8, a gearbox 87 and/or a clutch 88 enable more shaft speed variation between the gas generator 100 and the propulsor 10. More specifically, gearbox 87 allows for optimum shaft speeds of both the power turbine 13 and the propulsor 10. The clutch 88 mechanically isolates the propulsor 10 from the gas generator 100 during quiet mode. This mechanical isolation reduces or eliminates any need to evacuate the power turbine cavity to minimize windage losses.

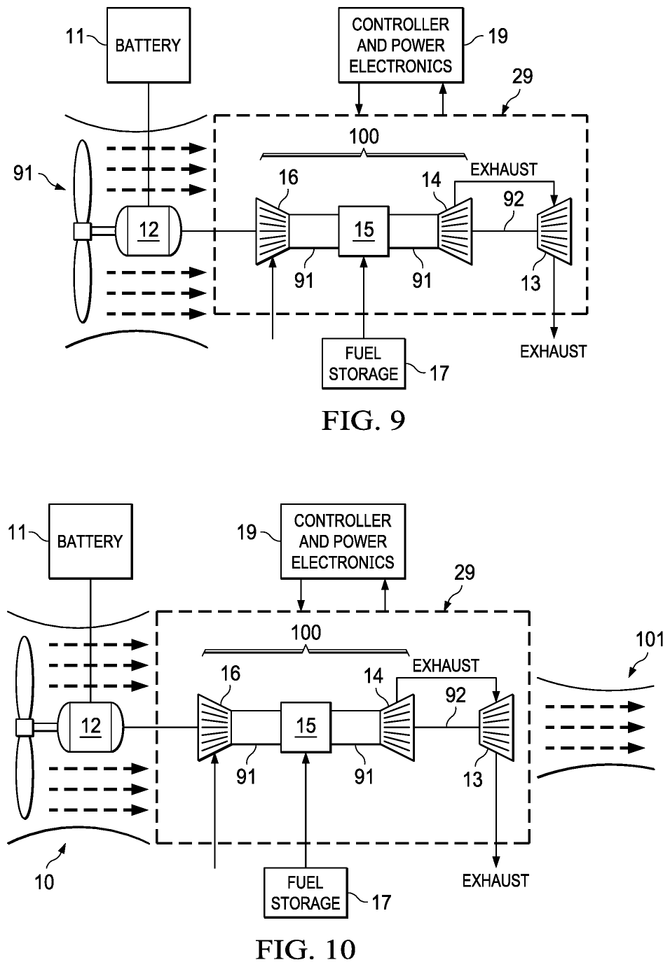

FIG. 9 illustrates a dual-spool shaft arrangement in which the gas generator system 100 has two concentric shafts 91 and 92. The additional shaft 91 is a hollow shaft, which is the compressor shaft. Shaft 92 is the power shaft, allowing the power turbine 13 to drive the motor/generator 12 and propulsor 10.

In the embodiment of FIG. 9, the flow path from the gas generator turbine 14 to the power turbine 13 is more direct. This is because the two turbines are likely to be more closely coupled in a concentric shaft design. This mechanical integration can lead to a reduction in overall system weight.

Exhaust from the power turbine 13 can be directed strategically. This can facilitate low visibility from ground observers since the hot exhaust and turbomachinery noise can be pointed towards the sky.

FIG. 10 illustrates a variation of the embodiment of FIG. 9 in that exhaust from the power turbine 13 is ejected through a nozzle 101, thus contributing to the overall thrust of the propulsion system. This may be attractive to consider as part of the trade space for a given system level requirement. Since the power turbine 13 is expected to be used only during high thrust events, this solution may allow a reduction in the size of propulsor 10, reducing the overall power and propulsion system weight.

What is claimed is:

1. A hybrid propulsion system for an aircraft, the aircraft having a propulsor, an onboard battery pack, and a fuel tank for storing fuel, comprising:
a motor/generator for driving the propulsor and/or generating electrical energy to be stored in the battery pack;
a power turbine directly connected to the motor/generator via a power shaft;
a gas generator system comprising: a compressor for providing compressed air; a combustor for receiving and combusting the fuel and the compressed air, thereby providing combustor exhaust gas output; a gas generator turbine driven by the combustor exhaust gas output and operable to drive the compressor via a compressor shaft and to produce gas generator exhaust gas output;
wherein the gas generator turbine drives only the compressor via the compressor shaft; and
wherein the gas generator turbine drives only the power turbine with the gas generator exhaust gas output.

2. The hybrid propulsion system of claim 1, wherein the propulsor is at least one ducted fan or at least one propeller.

3. The hybrid propulsion system of claim 1, wherein the propulsion system is operable in at least one gas generator mode, in which the gas generator system is active, thereby providing exhaust to the power turbine, which drives the motor/generator and the propulsor.

4. The hybrid propulsion system of claim 1, wherein at least one of the gas generator modes is a mode in which electrical generation from the motor/generator charges the battery pack.

5. The hybrid propulsion system of claim 1, wherein at least one of the gas generator modes is a mode in which electrical generation from the motor/generator powers on-board electrical equipment.

6. The hybrid propulsion system of claim 1, wherein the propulsion system is operable in at least one quiet mode, in which the gas generator system is not active, and the propulsor is driven solely by the motor/generator.

7. The hybrid propulsion system of claim 6, wherein the gas generator system is contained within a housing, which may be evacuated during the quiet mode.

8. The hybrid propulsion system of claim 6, further comprising a clutch operable to mechanically isolate the propulsor from the gas generator system during the quiet mode.

9. The hybrid propulsion system of claim 1, further comprising a gearbox on the power shaft.

10. The hybrid propulsion system of claim 1, wherein the power shaft is from the turbine directly to the motor generator.

11. The hybrid propulsion system of claim 1, wherein the gas generator system has two concentric shafts, one of which is the compressor shaft and the other of which is the power shaft.

12. The hybrid propulsion system of claim 1, wherein the power turbine generates external exhaust to the atmosphere and further comprising a nozzle for receiving and emitting the external exhaust.

13. A method of using a hybrid propulsion system for an aircraft, the aircraft having a propulsor, an onboard battery pack, and a fuel tank for storing fuel, comprising:
using a motor/generator to drive the propulsor and/or to generate electrical energy to be stored in the battery pack;
connecting a power turbine directly to the motor/generator via a power shaft;
using exhaust from a gas generator system to drive the power turbine, the gas generator system having: a compressor for providing compressed air; a combustor for receiving and combusting the fuel and the compressed air, thereby providing combustor exhaust gas output; and a gas generator turbine driven by the combustor exhaust gas output and operable to drive the compressor via a compressor shaft and to produce gas generator exhaust gas output;
wherein the gas generator turbine drives only the compressor with the compressor shaft; and
wherein the gas generator turbine drives only the power turbine with the gas generator exhaust gas output.
